(19) United States
(12) Patent Application Publication
(10) Pub. No.: US 2026/0110632 A1
(43) Pub. Date: Apr. 23, 2026

(54) METHODS FOR SOLUTION-PHASE ANALYSIS OF IMPURITIES IN MOLYBDENUM PRECURSORS

(71) Applicant: ENTEGRIS, INC., Billerica, MA (US)

(72) Inventors: Hyein Do, Georgetown, TX (US); Jeramie Rushing, Georgetown, TX (US); Brian Fitchett, Leander, TX (US)

(21) Appl. No.: 19/360,942

(22) Filed: Oct. 16, 2025

Related U.S. Application Data
(60) Provisional application No. 63/708,635, filed on Oct. 17, 2024.

(51) Int. Cl. G01N 21/3563; G01N 21/35

(52) U.S. Cl. CPC G01N 21/3563; G01N 2021/3572; G01N 2021/3595

(57) ABSTRACT

Methods for solution-phase analysis of impurities in molybdenum precursors are provided. The method comprises obtaining a solid composition. The solid composition comprises a first molybdenum oxyhalide compound. The solid composition comprises 5% or less by weight of at least one impurity based on a total weight of the solid composition. The at least one impurity comprises a second molybdenum oxyhalide compound. The second molybdenum oxyhalide compound is different from the first molybdenum oxyhalide compound. The method comprises dissolving the solid composition in a solvent to obtain a solution comprising the first molybdenum oxyhalide compound and the second molybdenum oxyhalide compound. The method comprises detecting a presence of the second molybdenum oxyhalide compound in the solution.

### CROSS-REFERENCE TO RELATED APPLICATIONS

This application claims the benefit under 35 USC 119 of U.S. Provisional Patent Application No. 63/708,635, filed Oct. 17, 2024, the disclosure of which is hereby incorporated herein by reference in its entirety.

### BACKGROUND

Molybdenum precursors are utilized in vapor deposition processes in the manufacture of semiconductor devices. However, impurities, both known and unknown, will exist in the precursors.

### SUMMARY

Some embodiments relate to a method. In some embodiments, the method comprises obtaining a solid composition. In some embodiments, the solid composition comprises a first molybdenum oxyhalide compound. In some embodiments, the solid composition comprises 5% or less by weight of at least one impurity based on a total weight of the solid composition. In some embodiments, the at least one impurity comprises a second molybdenum oxyhalide compound. In some embodiments, the second molybdenum oxyhalide compound is different from the first molybdenum oxyhalide compound. In some embodiments, the method comprises dissolving the solid composition in a solvent to obtain a solution comprising the first molybdenum oxyhalide compound and the second molybdenum oxyhalide compound. In some embodiments, the method comprises detecting a presence of the second molybdenum oxyhalide compound in the solution.

Some embodiments relate to a method. In some embodiments, the solid composition comprises a first molybdenum oxyhalide compound. In some embodiments, the solid composition comprises 5% or less by weight of at least one impurity based on a total weight of the solid composition. In some embodiments, the at least one impurity comprises a second molybdenum oxyhalide compound. In some embodiments, the second molybdenum oxyhalide compound is different from the first molybdenum oxyhalide compound. In some embodiments, the method comprises dissolving the solid composition in a solvent to obtain a solution comprising the first molybdenum oxyhalide compound and the second molybdenum oxyhalide compound. In some embodiments, the method comprises measuring an amount of the second molybdenum oxyhalide compound in the solution.

### BRIEF DESCRIPTION OF THE DRAWINGS

FIG. 1 is a flowchart of a method for detecting a presence of a second molybdenum oxyhalide compound in a solution, according to some embodiments.

FIG. 2 is a flowchart of a method for measuring an amount of a second molybdenum oxyhalide compound in a solution, according to some embodiments.

FIG. 3 is a portion of an FTIR spectrum, according to some embodiments.

FIG. 4 is a demonstration of the linearity of the MoOCl₄ concentration based on the integrated peak area shown in FIG. 3.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Any prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term "based on" is not exclusive and allows for being based on additional factors not described, unless the context clearly dictates otherwise. In addition, throughout the specification, the meaning of "a," "an," and "the" include plural references. The meaning of "in" includes "in" and "on."

Current methods of testing molybdenum precursors, such as gas chromatography, nuclear magnetic resonance (NMR) spectroscopy, and ¹H proton nuclear magnetic resonance (NMR) spectroscopy are difficult tools to use to analyze impurities in molybdenum precursor using liquid samples and/or heat. In some instances, for example ¹H NMR, the method does not detect unknown impurities. At least some of these embodiments relate to methods for solution-phase analysis of impurities in molybdenum precursors for a microelectronic device, such as, a 3D NAND structure, and the like.

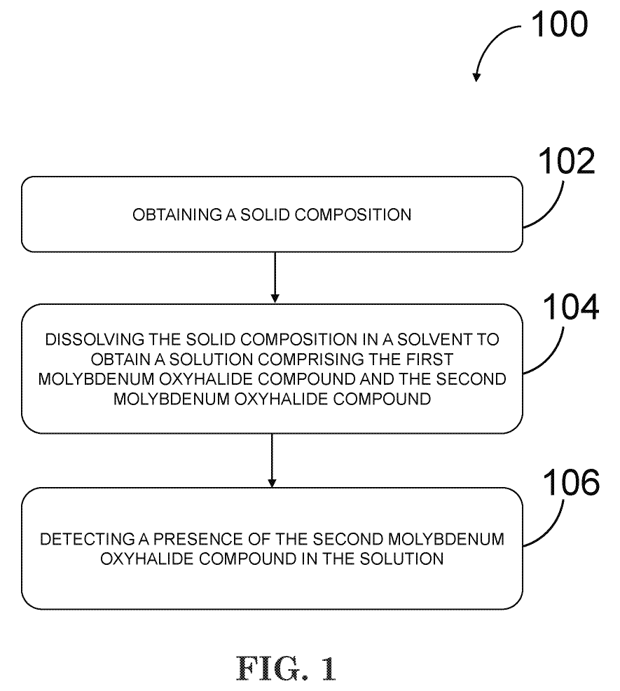

FIG. 1 is a flowchart of a method for detecting a presence of a second molybdenum oxyhalide compound in a solution, according to some embodiments. As shown in FIG. 1, the method for detecting a presence of a second molybdenum oxyhalide compound in a solution may comprise one or more of the following steps: obtaining a solid composition 102, dissolving the solid composition in a solvent to obtain a solution comprising the first molybdenum oxyhalide compound and the second molybdenum oxyhalide compound 104, and detecting a presence of the second molybdenum oxyhalide compound in the solution 106.

At step 102, in some embodiments, the method comprises obtaining a solid composition. In some embodiments, the solid composition comprises a first molybdenum oxyhalide compound. In some embodiments, the first molybdenum oxyhalide compound is a molybdenum dichloride dioxide (MoO₂Cl₂).

In some embodiments, the first molybdenum oxyhalide compound is present in an amount of 95% to 99.9999% by weight based on a total weight of the solid composition, or any range or subrange between 95% and 99.9999%. For example, in some embodiments, the first molybdenum oxyhalide compound is present in an amount of 96% to 99.999%, 97% to 99.99%, or 98% to 99.9% by weight based on a total weight of the solid composition. In some embodiments, the first molybdenum oxyhalide compound is present in an amount of 95% to 99.999%, 95% to 99.99%, 95% to 99.9%, 95% to 99.9%, 95% to 99%, 95% to 98%, 95% to 97%, or 95% to 96% by weight based on a total weight of the solid composition. In some embodiments, the first molybdenum oxyhalide compound is present in an amount of 96% to 99.9999%, 97% to 99.9999%, 98% to 99.9999%, 99% to 99.9999%, 99.9% to 99.9999%, 99.99% to 99.9999%, or 99.999% to 99.9999% by weight based on a total weight of the solid composition.

In some embodiments, the solid composition comprises 5% or less by weight of at least one impurity based on a total weight of the solid composition. For example, in some embodiments, the solid composition comprises 0.0001% to 5% by weight of at least one impurity based on a total weight of the solid composition, or any range or subrange between 0.0001% and 5%. In some embodiments, the solid composition comprises 0.1% to 4%, 0.5% to 3%, or 1% to 2% by weight of at least one impurity based on a total weight of the solid composition. In some embodiments, the solid composition comprises 0.0001% to 4%, 0.0001% to 3%, 0.0001% to 2%, 0.0001% to 1%, 0.0001% to 0.5%, 0.0001% to 0.1%, 0.0001% to 0.05%, 0.0001% to 0.01%, 0.0001% to 0.005%, 0.0001% to 0.001%, or 0.0001% to 0.0005% by weight of at least one impurity based on a total weight of the solid composition. In some embodiments, the solid composition comprises 0.0005% to 5%, 0.001% to 5%, 0.005% to 5%, 0.01% to 5%, 0.05% to 5%, 0.1% to 5%, 0.5% to 5%, 1% to 5%, 1% to 4%, 1% to 3%, or 1% to 2% by weight of at least one impurity based on a total weight of the solid composition.

In some embodiments, the at least one impurity comprises a second molybdenum oxyhalide compound. In some embodiments, the second molybdenum oxyhalide compound is a molybdenum tetrachloride oxide (MoOCl₄).

In some embodiments, the second molybdenum oxyhalide produces a peak in a Fourier-transform infrared spectroscopy (FTIR) spectrum at a wavenumber of 970 cm⁻¹ to 990 cm⁻¹, or any range or subrange between 970 cm⁻¹ and 990 cm⁻¹. For example, in some embodiments, the second molybdenum oxyhalide produces a peak in an FTIR spectrum at a wavenumber of 972 cm⁻¹ to 988 cm⁻¹, 974 cm⁻¹ to 986 cm⁻¹, 976 cm⁻¹ to 984 cm⁻¹, or 978 cm⁻¹ to 982 cm⁻¹. In some embodiments, the second molybdenum oxyhalide produces a peak in an FTIR spectrum at a wavenumber of 970 cm⁻¹ to 988 cm⁻¹, 970 cm⁻¹ to 986 cm⁻¹, 970 cm⁻¹ to 984 cm⁻¹, 970 cm⁻¹ to 982 cm⁻¹, 970 cm⁻¹ to 980cm⁻¹, 970 cm⁻¹ to 978 cm⁻¹, 970 cm⁻¹ to 976 cm⁻¹, 970 cm⁻¹ to 974 cm⁻¹, or 970 cm⁻¹ to 972 cm⁻¹. In some embodiments, the second molybdenum oxyhalide produces a peak in an FTIR spectrum at a wavenumber of 972 cm⁻¹ to 990 cm⁻¹, 974 cm⁻¹ to 990 cm⁻¹, 976 cm⁻¹ to 990 cm⁻¹, 978 cm⁻¹ to 990 cm⁻¹, 980 cm⁻¹ to 990 cm⁻¹, 982 cm⁻¹ to 990 cm⁻¹, 984 cm⁻¹ to 990 cm⁻¹, or 988 cm⁻¹ to 990 cm⁻¹.

In some embodiments, the second molybdenum oxyhalide compound is different from the first molybdenum oxyhalide compound. In some embodiments, the second molybdenum oxyhalide compound is not MoO₂Cl₂.

At step 104, in some embodiments, the method comprises dissolving the solid composition in a solvent to obtain a solution comprising the first molybdenum oxyhalide compound and the second molybdenum oxyhalide compound. In some embodiments, the solvent only dissolves the first molybdenum oxyhalide compound and the second molybdenum oxyhalide compound. In some embodiments, the solvent does not dissolve compounds other than the first molybdenum oxyhalide compound and the second molybdenum oxyhalide compound. In some embodiments, to the extent other species are dissolved by the solvent, the other species are negligible or undetectable.

In some embodiments, the solvent comprises an amide. In some embodiments, the amide comprises a primary amide, a secondary amide, a tertiary amide, a cyclic amide, or any combination thereof. In some embodiments, the amide comprises a formamide, an acetamide, a propionamide, a butyramide, a valeramide, a caproamide, a pyrrolidone, an isobutyramide, a caprolactam, a piperidone, or any combination thereof.

In some embodiments, the solvent does not comprise a dichloromethane, an acetonitrile, an acetone, a pyridine, a tetrahydrofuran, a dimethoxyethane, a benzonitrile, or any combination thereof. In some embodiments, the solvent does not comprise a dichloromethane. In some embodiments, the solvent does not comprise an acetonitrile. In some embodiments, the solvent does not comprise an acetone. In some embodiments, the solvent does not comprise a pyridine. In some embodiments, the solvent does not comprise a tetrahydrofuran. In one embodiment, the solvent comprises dimethylformamide. In some embodiments, the solvent does not comprise a dimethoxyethane. In some embodiments, the solvent does not comprise a benzonitrile. In some embodiments, dichloromethane, acetonitrile, acetone, pyridine, tetrahydrofuran, dimethoxyethane, benzonitrile, ethyl acetate, toluene, and 1,10-Phenanthroline did not function as effective solvents. In some embodiments, the desired materials were not sufficiently soluble in the solvent or the peaks for the different molybdenum oxyhalides overlapped.

In some embodiments, the solvent does not produce a peak in an FTIR spectrum at a wavenumber of 880 cm⁻¹ to 1000 cm⁻¹, or any range or subrange between 880 cm⁻¹ and 1000 cm⁻¹. For example, in some embodiments, the solvent does not produce a peak in an FTIR spectrum at a wavenumber of 890 cm⁻¹ to 990 cm⁻¹, 900 cm⁻¹ to 980 cm⁻¹, 910 cm⁻¹ to 970 cm⁻¹, 920 cm⁻¹ to 960 cm⁻¹, or 930 cm⁻¹ to 950 cm⁻¹. In some embodiments, the solvent does not produce a peak in an FTIR spectrum at a wavenumber of 890 cm⁻¹ to 1000 cm⁻¹, 900 cm⁻¹ to 1000 cm⁻¹, 910 cm⁻¹ to 1000 cm⁻¹, 920 cm⁻¹ to 1000 cm⁻¹, 930 cm⁻¹ to 1000 cm⁻¹, 940 cm⁻¹ to 1000 cm⁻¹, 950 cm⁻¹ to 1000 cm⁻¹, 960 cm⁻¹ to 1000 cm⁻¹, 970 cm⁻¹ to 1000 cm⁻¹, 980 cm⁻¹ to 1000 cm⁻¹, or 990 cm⁻¹ to 1000 cm⁻¹. In some embodiments, the solvent does not produce a peak in an FTIR spectrum at a wavenumber of 880 cm⁻¹ to 990 cm⁻¹, 880 cm⁻¹ to 980 cm⁻¹, 880 cm⁻¹ to 970 cm⁻¹, 880 cm⁻¹ to 960 cm⁻¹, 880 cm⁻¹ to 950 cm⁻¹, 880 cm⁻¹ to 940 cm⁻¹, 880 cm⁻¹ to 930 cm⁻¹, 880 cm⁻¹ to 920 cm⁻¹, 880 cm⁻¹ to 910 cm⁻¹, 880 cm⁻¹ to 900 cm⁻¹, or 880 cm⁻¹ to 890 cm⁻¹.

In some embodiments, a peak representing the second molybdenum oxyhalide compound in an FTIR spectrum has a wavenumber that is 1% to 30%, or any range or subrange between 1% to 30%, greater than a peak representing the solvent in the FTIR spectrum. In some embodiments, a peak representing the second molybdenum oxyhalide compound in an FTIR spectrum has a wavenumber that is 5% to 30%, 10% to 30%, 15% to 30%, 20% to 30%, 25% to 30%, 1% to 25%, 1% to 20%, 1% to 15%, 1% to 10%, or 1% to 5% greater than a peak representing the solvent in the FTIR spectrum.

In some embodiments, a peak representing the second molybdenum oxyhalide compound in an FTIR spectrum has a wavenumber that is 1% to 30%, or any range or subrange between 1% to 30%, less than a peak representing the solvent in the FTIR spectrum. In some embodiments, a peak representing the second molybdenum oxyhalide compound in an FTIR spectrum has a wavenumber that is 5% to 30%, 10% to 30%, 15% to 30%, 20% to 30%, 25% to 30%, 1% to 25%, 1% to 20%, 1% to 15%, 1% to 10%, or 1% to 5% less than a peak representing the solvent in the FTIR spectrum.

In some embodiments, the solvent is liquid at room temperature.

At step 106, in some embodiments, the method comprises detecting a presence of the second molybdenum oxyhalide compound in the solution. In some embodiments, the detecting is conducted using FTIR spectroscopy. In some embodiments, the detecting is conducted using at least one of a near-infrared spectroscopy, a Raman spectroscopy, a UV-vis spectroscopy, or any combination thereof. In some embodiments, the detecting is conducted using a near-infrared spectroscopy. In some embodiments, the detecting is conducted using a Raman spectroscopy. In some embodiments, the detecting is conducted using a UV-vis spectroscopy.

In some embodiments, the detecting comprises measuring an amount of second molybdenum oxyhalide compound in the solution.

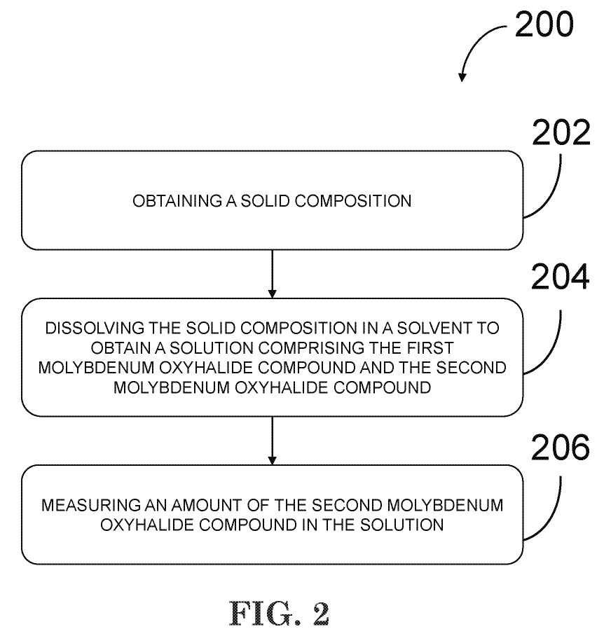

FIG. 2 is a flowchart of a method for measuring an amount of a second molybdenum oxyhalide compound in a solution, according to some embodiments. As shown in FIG. 2, the method for measuring an amount of a second molybdenum oxyhalide compound in a solution may comprise one or more of the following steps: obtaining a solid composition 202, dissolving the solid composition in a solvent to obtain a solution comprising the first molybdenum oxyhalide compound and the second molybdenum oxyhalide compound 204, and measuring an amount of the second molybdenum oxyhalide compound in the solution 206.

At step 202, in some embodiments, the method comprises obtaining a solid composition. In some embodiments, the solid composition comprises a first molybdenum oxyhalide compound. In some embodiments, the first molybdenum oxyhalide compound is a molybdenum dichloride dioxide (MoO₂Cl₂).

In some embodiments, the first molybdenum oxyhalide compound is present in an amount of 95% to 99.9999% by weight based on a total weight of the solid composition, or any range or subrange between 95% and 99.9999%. For example, in some embodiments, the first molybdenum oxyhalide compound is present in an amount of 96% to 99.999%, 97% to 99.99%, or 98% to 99.9% by weight based on a total weight of the solid composition. In some embodiments, the first molybdenum oxyhalide compound is present in an amount of 95% to 99.999%, 95% to 99.99%, 95% to 99.9%, 95% to 99.9%, 95% to 99%, 95% to 98%, 95% to 97%, or 95% to 96% by weight based on a total weight of the solid composition. In some embodiments, the first molybdenum oxyhalide compound is present in an amount of 96% to 99.9999%, 97% to 99.9999%, 98% to 99.9999%, 99% to 99.9999%, 99.9% to 99.9999%, 99.99% to 99.9999%, or 99.999% to 99.9999% by weight based on a total weight of the solid composition.

In some embodiments, the solid composition comprises 5% or less by weight of at least one impurity based on a total weight of the solid composition. For example, in some embodiments, the solid composition comprises 0.0001% to 5% by weight of at least one impurity based on a total weight of the solid composition, or any range or subrange between 0.0001% and 5%. In some embodiments, the solid composition comprises 0.1% to 4%, 0.5% to 3%, or 1% to 2% by weight of at least one impurity based on a total weight of the solid composition. In some embodiments, the solid composition comprises 0.0001% to 4%, 0.0001% to 3%, 0.0001% to 2%, 0.0001% to 1%, 0.0001% to 0.5%, 0.0001% to 0.1%, 0.0001% to 0.05%, 0.0001% to 0.01%, 0.0001% to 0.005%, 0.0001% to 0.001%, or 0.0001% to 0.0005% by weight of at least one impurity based on a total weight of the solid composition. In some embodiments, the solid composition comprises 0.0005% to 5%, 0.001% to 5%, 0.005% to 5%, 0.01% to 5%, 0.05% to 5%, 0.1% to 5%, 0.5% to 5%, 1% to 5%, 1% to 4%, 1% to 3%, or 1% to 2% by weight of at least one impurity based on a total weight of the solid composition.

In some embodiments, the at least one impurity comprises a second molybdenum oxyhalide compound. In some embodiments, the second molybdenum oxyhalide is a molybdenum tetrachloride oxide (MoOCl₄). In some embodiments, the second molybdenum oxyhalide produces a peak in an FTIR spectrum at a wavenumber of 970 cm⁻¹ to 990 cm⁻¹, as described herein. In some embodiments, the second molybdenum oxyhalide compound is different from the first molybdenum oxyhalide compound.

At step 204, in some embodiments, the method comprises dissolving the solid composition in a solvent to obtain a solution comprising the first molybdenum oxyhalide compound and the second molybdenum oxyhalide compound. In some embodiments, the solvent only dissolves the first molybdenum oxyhalide compound and the second molybdenum oxyhalide compound.

In some embodiments, the solvent comprises an amide. In some embodiments, the amide comprises a primary amide, a secondary amide, a tertiary amide, a cyclic amide, or any combination thereof. In some embodiments, the amide comprises a formamide, an acetamide, a propionamide, a butyramide, a valeramide, a caproamide, a pyrrolidone, an isobutyramide, a caprolactam, a piperidone, or any combination thereof.

In some embodiments, the solvent does not produce a peak in an FTIR spectrum at a wavenumber of 880 cm⁻¹ to 1000 cm⁻¹, as described herein.

In some embodiments, the solvent does not comprise at least one of a dichloromethane, an acetonitrile, an acetone, a pyridine, a tetrahydrofuran, a dimethoxyethane, a benzonitrile, or any combination thereof.

In some embodiments, the solvent is liquid at room temperature.

At step 206, in some embodiments, the method comprises measuring an amount of the second molybdenum oxyhalide compound in the solution. In some embodiments, the measuring is conducted using FTIR spectroscopy. In some embodiments, the measuring is conducted using at least one of a near-infrared spectroscopy, a Raman spectroscopy, a UV-vis spectroscopy, or any combination thereof. In some embodiments, the measuring is conducted using a near-infrared spectroscopy. In some embodiments, the measuring is conducted using a Raman spectroscopy. In some embodiments, the measuring is conducted using a UV-vis spectroscopy. In some embodiments, the amount of the second molybdenum oxyhalide in the solution corresponds to an amount of the second molybdenum oxyhalide in the solid composition.

Any one or more of the embodiments disclosed herein shall be understood to be combinable without departing from the scope or spirit of the disclosure.

### EXAMPLE 1

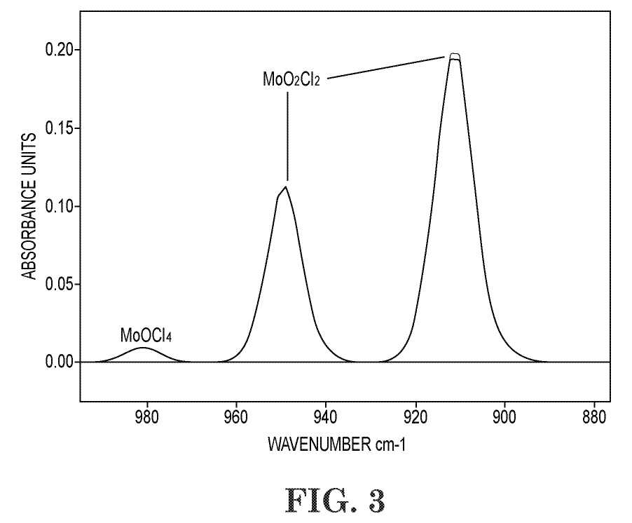

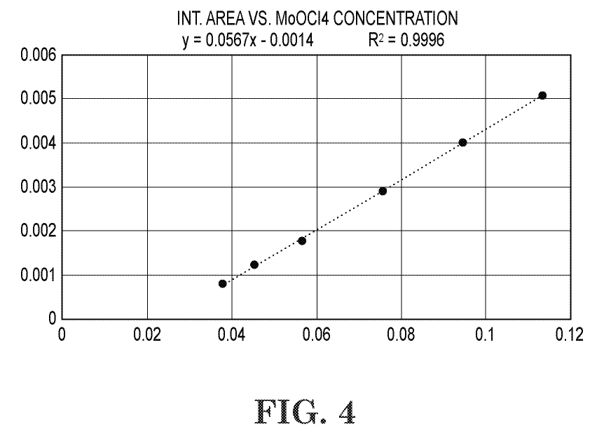

A solid composition comprising 95% or greater by weight of molybdenum dichloride dioxide (MoO₂Cl₂) and 5% or less by weight of molybdenum tetrachloride oxide (MoOCl₄) was dissolved in a solvent to form a solution. Only the MoO₂Cl₂ and the MoOCl₄ were dissolved in the solvent. To the extent other species were dissolved by the solvent, this was either negligible or undetectable. The solution was analyzed using FTIR. FIG. 3 shows a portion of an FTIR spectrum showing the presence of both MoO₂Cl₂ and MoOCl₄ in the solution. FIG. 4 shows the relationship between MoOCl₄ concentration and integrated peak area to be linear.

### ASPECTS

Various Aspects are described below. It is to be understood that any one or more of the features recited in the following Aspect(s) can be combined with any one or more other Aspect(s).

Aspect 1. A method comprising:

obtaining a solid composition comprising:

a first molybdenum oxyhalide compound; and

5% or less by weight of at least one impurity based on a total weight of the solid composition,

wherein the at least one impurity comprises a second molybdenum oxyhalide compound;

wherein the second molybdenum oxyhalide compound is different from the first molybdenum oxyhalide compound;

dissolving the solid composition in a solvent to obtain a solution comprising the first molybdenum oxyhalide compound and the second molybdenum oxyhalide compound; and

detecting a presence of the second molybdenum oxyhalide compound in the solution.

Aspect 2. The method according to Aspect 1, wherein the first molybdenum oxyhalide compound is a molybdenum dichloride dioxide.

Aspect 3. The method according to any one of Aspects 1-2, wherein the second molybdenum oxyhalide compound is a molybdenum tetrachloride oxide.

Aspect 4. The method according to any one of Aspects 1-3, wherein the first molybdenum oxyhalide compound is present in an amount of 95% to 99.9999% by weight based on a total weight of the solid composition.

Aspect 5. The method according to any one of Aspects 1-4, wherein the detecting is conducted using FTIR spectroscopy.

Aspect 6. The method according to any one of Aspects 1-5, wherein the solvent comprises an amide.

Aspect 7. The method according to any one of Aspects 1-6, wherein the solvent only dissolves the first molybdenum oxyhalide compound and the second molybdenum oxyhalide compound.

Aspect 8. The method according to any one of Aspects 1-7, wherein the second molybdenum oxyhalide compound produces a peak in an FTIR spectrum at a wavenumber of 970 cm⁻¹ to 990 cm⁻¹.

Aspect 9. The method according to any one of Aspects 1-8, wherein the solvent does not produce a peak in an FTIR spectrum at a wavenumber of 880 cm⁻¹ to 1000 cm⁻¹.

Aspect 10. The method according to any one of Aspects 1-9, wherein the solvent is liquid at room temperature.

Aspect 11. A method comprising:

obtaining a solid composition comprising:

a first molybdenum oxyhalide compound; and

5% or less by weight of at least one impurity based on a total weight of the solid composition,

wherein the at least one impurity comprises a second molybdenum oxyhalide compound,

wherein the second molybdenum oxyhalide compound is different from the first molybdenum oxyhalide compound;

dissolving the solid composition in a solvent to obtain a solution comprising the first molybdenum oxyhalide compound and the second molybdenum oxyhalide compound; and

measuring an amount of the second molybdenum oxyhalide compound in the solution.

Aspect 12. The method according to Aspect 11, wherein the first molybdenum oxyhalide compound is a molybdenum dichloride dioxide.

Aspect 13. The method according to any one of Aspects 11-12, wherein the second molybdenum oxyhalide compound is a molybdenum tetrachloride oxide.

Aspect 14. The method according to any one of Aspects 11-13, wherein the first molybdenum oxyhalide compound is present in an amount of 95% to 99.9999% by weight based on a total weight of the solid composition.

Aspect 15. The method according to any one of Aspects 11-14, wherein the measuring is conducted using FTIR spectroscopy.

Aspect 16. The method according to any one of Aspects 11-15, wherein the solvent comprises an amide.

Aspect 17. The method according to any one of Aspects 11-16, wherein the solvent only dissolves the first molybdenum oxyhalide compound and the second molybdenum oxyhalide compound.

Aspect 18. The method according to any one of Aspects 11-17, wherein the second molybdenum oxyhalide compound produces a peak in an FTIR spectrum at a wavenumber of 970 cm⁻¹ to 990 cm⁻¹.

Aspect 19. The method according to any one of Aspects 11-18, wherein the solvent does not produce a peak in an FTIR spectrum at a wavenumber of 880 cm⁻¹ to 1000 cm⁻¹.

Aspect 20. The method according to any one of Aspects 11-19, wherein the solvent is liquid at room temperature.

What is claimed is:

1. A method comprising:
obtaining a solid composition comprising:
a first molybdenum oxyhalide compound; and
5% or less by weight of at least one impurity based on a total weight of the solid composition,
wherein the at least one impurity comprises a second molybdenum oxyhalide compound;
wherein the second molybdenum oxyhalide compound is different from the first molybdenum oxyhalide compound;
dissolving the solid composition in a solvent to obtain a solution comprising the first molybdenum oxyhalide compound and the second molybdenum oxyhalide compound; and
detecting a presence of the second molybdenum oxyhalide compound in the solution.

2. The method of claim 1, wherein the first molybdenum oxyhalide compound is a molybdenum dichloride dioxide.

3. The method of claim 1, wherein the second molybdenum oxyhalide compound is a molybdenum tetrachloride oxide.

4. The method of claim 1, wherein the first molybdenum oxyhalide compound is present in an amount of 95% to 99.9999% by weight based on a total weight of the solid composition.

5. The method of claim 1, wherein the detecting is conducted using FTIR spectroscopy.

6. The method of claim 1, wherein the solvent comprises an amide.

7. The method of claim 1, wherein the solvent only dissolves the first molybdenum oxyhalide compound and the second molybdenum oxyhalide compound.

8. The method of claim 1, wherein the second molybdenum oxyhalide compound produces a peak in an FTIR spectrum at a wavenumber of 970 cm⁻¹ to 990 cm⁻¹.

9. The method of claim 1, wherein the solvent does not produce a peak in an FTIR spectrum at a wavenumber of 880 cm⁻¹ to 1000 cm⁻¹.

10. The method of claim 1, wherein the solvent is liquid at room temperature.

11. A method comprising:
obtaining a solid composition comprising:
a first molybdenum oxyhalide compound; and
5% or less by weight of at least one impurity based on a total weight of the solid composition,
wherein the at least one impurity comprises a second molybdenum oxyhalide compound,
wherein the second molybdenum oxyhalide compound is different from the first molybdenum oxyhalide compound;
dissolving the solid composition in a solvent to obtain a solution comprising the first molybdenum oxyhalide compound and the second molybdenum oxyhalide compound; and
measuring an amount of the second molybdenum oxyhalide compound in the solution.

12. The method of claim 11, wherein the first molybdenum oxyhalide compound is a molybdenum dichloride dioxide.

13. The method of claim 11, wherein the second molybdenum oxyhalide compound is a molybdenum tetrachloride oxide.

14. The method of claim 11, wherein the first molybdenum oxyhalide compound is present in an amount of 95% to 99.9999% by weight based on a total weight of the solid composition.

15. The method of claim 11, wherein the measuring is conducted using FTIR spectroscopy.

16. The method of claim 11, wherein the solvent comprises an amide.

17. The method of claim 11, wherein the solvent only dissolves the first molybdenum oxyhalide compound and the second molybdenum oxyhalide compound.

18. The method of claim 11, wherein the second molybdenum oxyhalide compound produces a peak in an FTIR spectrum at a wavenumber of 970 cm⁻¹ to 990 cm⁻¹.

19. The method of claim 11, wherein the solvent does not produce a peak in an FTIR spectrum at a wavenumber of 880 cm⁻¹ to 1000 cm⁻¹.

20. The method of claim 11, wherein the solvent is liquid at room temperature.
